(19) United States
(12) Patent Application Publication
(10) Pub. No.: US 2003/0112200 A1
(43) Pub. Date: Jun. 19, 2003

(54) Horizontally polarized printed circuit antenna array

(75) Inventor: Ronald A. Marino, Valley Stream, NY (US)

Correspondence Address: SUGHRUE MION, PLLC, 2100 Pennsylvania Avenue, NW, Washington, DC, 20037-3213, US

(73) Assignee: ALCATEL, RADIO FREQUENCY SYSTEMS, INC.

(21) Appl. No.: 10/015,702

(22) Filed: Dec. 17, 2001

(51) Int. Cl. H01Q 21/08

(52) U.S. Cl. 343/824; 343/814

(57) ABSTRACT

An array of antenna elements including a feed board that includes a power divider network and a balun section. According to one aspect of the invention, there is provided a horizontally polarized antenna arrangement including a feed board, a plurality of horizontally polarized antenna elements, and a reflector. The antenna elements are a plurality of dipole pairs. The feed board has two faces. The first face includes a power network and a balun section, that feeds power to the plurality of antenna elements, and the second face includes a ground plane. The fact that the feed board includes a balun section allows the antenna elements to be etched on an inexpensive board or, in the alternative, allows the antenna elements to be individual wires or plates. The antenna arrangement also includes two tuning means, line extensions in the power network and tuning stubs etched to the ground layer, which make it easier to tune the antenna. In addition, one embodiment of the invention is configured so that the dipole arms are soldered to the feed network at points that are farther away from each other than existing antenna arrangements. This lowers the risk of solder bridging.

### FIELD OF THE INVENTION

The present invention generally relates to an antenna array in which a power feed network, including a balun section, is located on a single printed circuit board (PCB board).

### BACKGROUND OF THE INVENTION

Horizontally polarized antenna arrangements are typically arranged in a vertical row and radiate horizontally. The antenna elements provide a beam that is narrow in elevation, but broad in azimuth. By adding additional horizontal antenna elements to the arrangement, beam gain increases, while beam elevation becomes even narrower. U.S. Pat. No. 5,629,713 discusses horizontally polarized antenna arrays in some detail.

Existing horizontally polarized antenna systems use antenna dipoles mounted to separate PCB boards. Because the separate dipole boards include balun sections, which connect the balanced, antenna dipoles to an unbalanced feed power network included on a feed board, the dipole boards must be made of an expensive material, such as a microwave laminent material.

Mounting these antenna boards to the feed board requires at least two solder joints, connecting the dipole to both a ground and a microstrip power input feed. There is a significant risk of solder bridging during the assembly of these existing horizontally polarized antennas, because the locations where the dipoles are soldered to the feed board are very close to each other.

### SUMMARY OF THE INVENTION

This invention is a novel array of antenna elements including a feed board that includes a power divider network and a balun section.

According to one aspect of the invention, there is provided a horizontally polarized antenna arrangement including a feed board, a plurality of horizontally polarized antenna elements, and a reflector. The antenna elements are a plurality of dipole pairs. The feed board has two faces. The first face includes a power network and a balun section, that feeds power to the plurality of antenna elements, and the second face that includes a ground plane. The fact that the feed board includes a balun section allows the antenna elements to be etched on an inexpensive board or, in the alternative, allows the antenna elements to be individual wires or plates. The antenna arrangement also includes two tuning means, line extensions in the power network and tuning notches etched in the ground layer, which make it easier to tune the antenna.

In addition, one embodiment of the invention is configured so that the dipole arms are soldered to the feed network at points that are farther away from each other than existing antenna arrangements. This lowers the risk of solder bridging.

### BRIEF DESCRIPTION OF THE DRAWINGS

The advantages, nature and various additional features of the invention will appear more fully upon consideration of the illustrative embodiment of the invention which is schematically set forth in the drawings, in which:

FIG. 1 is a three dimensional view of the antenna arrangement;

FIG. 2 is a side view of the feed board without components formed on it;

FIG. 3 is a view of part of the first face of the feed board (power network and balun);

FIG. 4 is a view of part of the second face of the feed board (ground layer);

FIG. 5 is a top view of the single dipole board with a plurality of dipoles;

FIG. 6 is a three dimensional view of a single dipole pair showing the connection of the antenna feed to the dipole pair; and

FIG. 7 is a three dimensional view of a pair of wires uses an antenna dipole.

### DETAILED DESCRIPTION OF THE INVENTION

A preferred embodiment of the invention will be explained in further detail by making reference to the accompanying drawings, which do not limit the scope of the invention in any way.

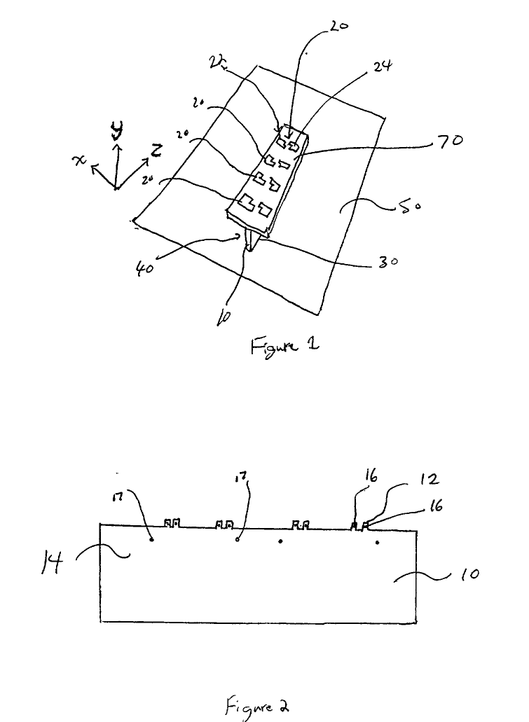

Referring to FIG. 1, the invention relates to an antenna arrangement 100 which includes a feed board 10, a plurality of horizontally polarized antenna elements 20, and a reflector 50. The antenna elements 20 are a plurality of dipole pairs consisting of first 22 and second 24 dipole arms that extend in one horizontal direction (x direction) and are arranged in a vertical row (z direction), i.e. normal to the ground. The antenna elements 20 are designed to radiate in the other horizontal direction (y-direction), which is normal to the reflector 50. The described embodiment uses a plurality of half wavelength dipole pairs 22, 24 The feed board 10 is positioned normal to the extended part of the dipole pair 22, 24, and the reflector 50 is positioned perpendicular to the feed board 10.

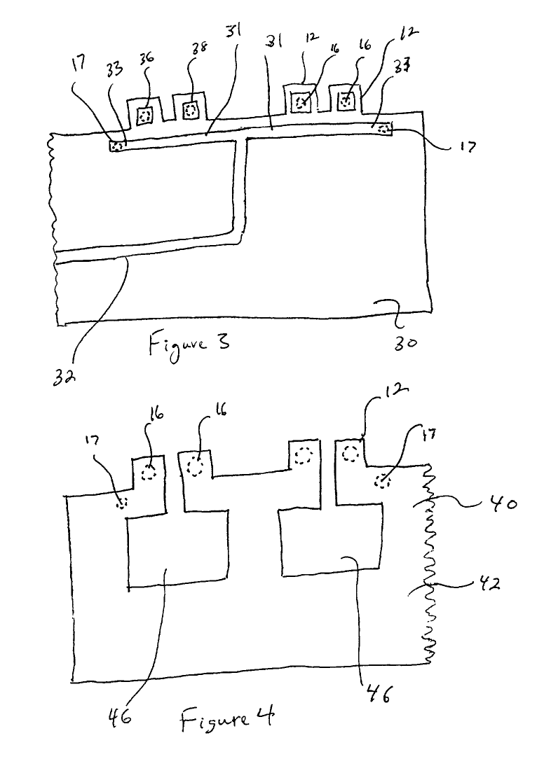

The feed board 10 has two faces 30, 40, and is made of an electrically insulating substrate, such as a microwave laminate material, such as PTFE or woven fiberglass. As shown in FIG. 2, the feed board 10 has a number of pairs of square board extensions 12 that extend slightly away from a main portion 14. There is one pair of board extensions 12 for each dipole pair 22, 24. Each board extension 12 includes metallized dipole pair through holes 16 that reach from one face 30 of the feed board 10 to the other 40. Additional metallized tuning stub through holes 17, which reach from one face 30 to the opposite face 40, are located at positions on the feed board 10 where ends of line extensions 33 of a power divider network 32 are located on the first face 30, as is discussed below.

Turning to FIG. 3, the first face 30 of the feed board 10 has a microstrip power divider network 32. Etched copper microstrip is used in a preferred embodiment, but this is not essential to the invention. The power divider network 32 feeds power to the plurality of antenna elements 20. The power divider network 32 includes several microstrip lines 31 that pass near pairs of metal pads 36, 38. There is one microstrip line 31 for each pair of pads 36, 38. The pads 36, 38 are etched on the board extensions 12 and are made of copper in the preferred embodiment, but this is not essential to the invention. Each microstrip line 31 includes a line extension 33 which extends a predetermined distance past a gap 18 formed between the pads 36, 38.

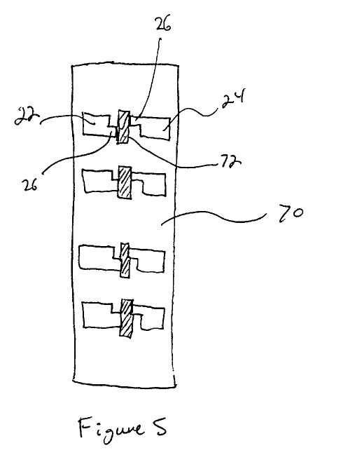

Referring to FIG. 4, the second face 40 of the feed board 10 has a ground plane 42 etched of copper, although it is only critical to the invention that the plane 42 be made of an electrically conductive material. The ground plane 42 includes sections etched to the extensions 12 of the feed board 10. A plurality of tuning notches 46, which are sections where the copper ground plane 42 has been removed, are formed onto the second face 40 at positions that are between and below the extensions 12, as shown in FIG. 4.

The extension metallized through holes 16 electrically connect the pads 36 and 38 to the part of the ground plane 42 etched to the extensions 12. The pads 36, 38, in combination with the ground plane 42 and metallized dipole pair through holes 16, form a pair of balanced feeds 60 that extend from the top of the feed board 10. These balanced feeds 60 are electrically connected to each antenna dipole pair 22, 24.

The power divider network 32 is an unbalanced RF transmission line. These lines 31 pass near each pair of pads 36, 38. The line extensions 33 of the microstrip lines 31, discussed above, continue a short distance beyond the location of the pads 36, 38. The line extensions 33 are connected to the ground plane 42 by the metallized tuning stub through holes 17. This provides a ground for the unbalanced RF signals. The microstrip line 31 traversing the gap 18 formed by the pads 36, 38 forms a balun 34, which provides a balanced RF signal to the dipole pairs 22, 24 from the unbalanced microstrip line 31. The microstrip line 31 induces a balanced RF signal of a given amplitude and phase in one of the pads 36 and induces a balanced RF signal of the same given amplitude and an opposite phase in the other pad 38. This provides each pair of balanced feeds 60, and thus the dipole pair 22, 24, with input signals of equal amplitude and opposite phase.

The plurality of horizontally polarized antenna elements 20 can be individual wires or plate structures; however, in a preferred embodiment of the invention, the plurality of antenna elements 20 are etched onto the single board 70. The board 70 may be made of material that is a less expensive than the feed board 10 material, such as an FR-4 fiberglass, without causing any significant degradation in antenna performance because the board 70, unlike existing antenna arrays, does not have a balun section 34.

FIG. 5 shows an embodiment in which the plurality of horizontally polarized antenna elements 20 are located on a single dipole board 70. A plurality of slots 72 are located between the dipole pair arms 22, 24. Each of the dipole arms 22, 24 has an arm extension 26 of a reduced width which is located next to the slots 72. The arm extensions 26 of the respective pairs are offset from each other, as shown in FIG. 5.

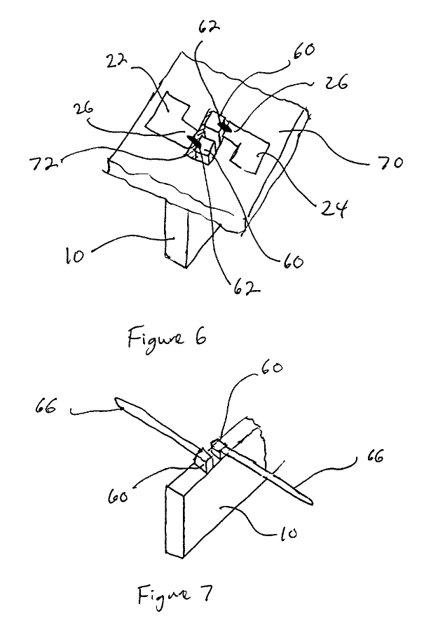

Referring to FIG. 6, a preferred embodiment of the invention is designed so that the antenna feeds 60 that extend from the feed board 10 protrude through the slots 72 in the dipole board 70 to a top of the dipole arms 22, 24. The antenna feeds 60 preferably extend beyond the thickness of the dipole arms 22, 24 so that the feeds 60 can be soldered to the tops of the arm extensions 26 of dipole arms 22, 24.

In existing antenna arrays, solder connections are made from a balun section located on the bottom of the antenna elements to the power network. The described embodiment's solder connection 62 on the top of the dipole arms 22, 24 is easier to make than the solder connection described above for existing antenna arrays. Furthermore, the arm extensions 26 of dipole arms 22, 24 reduce the chance of solder bridging between the antenna feeds 60 and, therefore, make it easier to assemble the antenna arrangement 100.

FIG. 7 illustrates an alternative embodiment that uses individual wires 66 as antenna elements 20 instead of the single dipole board 70 with a plurality of antennas. Plate structures can alternatively be used as antennas in this embodiment. This provides additional cost savings.

Tuning of the antenna arrangement 100 is accomplished through two tuning devices, tuning notches 46 and line extensions 33. A change in the size or shape of an individual tuning notch 46 may be used to optimize the match of the microstrip line 31 to the dipoles 22, 24, and a change in length of each line extension 33 past the pads 36, 38 also may be used to optimize the match. The use of these two tuning mechanisms makes it very easy to tune the antenna arrangement 100 so that it provides an optimized antenna voltage standing wave ratio (VSWR).

The described embodiment uses four one-half wavelength long dipoles pairs, as well as four pairs of antenna feeds 60, four line extensions 33, and four tuning notches 46; however, the invention is not limited in this respect.

Applications of the present invention include the use of the antenna arrangement 100 as a base station in a communications systems. These systems include, but are not limited to multi-channel, multi-point distribution services (MMDS), cellular systems, RADAR systems, or personal communications systems (PCS). The invention can be used in a dual polarization array or a scanning array. One embodiment of the present invention has a bandwidth of 2.4 to 2.69 GHz for an MMDS system, but communications systems that use this antenna arrangement can have operating frequencies up to 40 GHz, an operating bandwidth of 50% with a resulting VSWR of less than 2:1.

It is of course understood that departures can be made from the preferred embodiment of the invention by those of ordinary skill in the art without departing from the spirit and scope of the invention that is limited only by the following claims.

What is claimed is:

1. An antenna arrangement, comprising:
a plurality of horizontally polarized antenna elements; and
a feed board made of an electrically insulating substrate with a first face and a second face opposite the first face;
wherein a power divider network and a balun section are located on the first face, and an electrically conductive ground layer is located on the second face.

2. The antenna arrangement of claim 1, wherein the plurality of horizontally polarized antenna elements are dipoles, each with a first arm and a second arm,
wherein the first arm is connected to a antenna feed, which provides the first arm with an RF signal of a given amplitude and phase, and the second arm is connected to a second antenna feed, which provides the second arm with an RF signal of the given amplitude and an opposite phase.

3. The antenna arrangement of claim 2, wherein the plurality of horizontally polarized antenna elements are located on a single dipole board.

4. The antenna arrangement of claim 3, wherein the dipole board has a plurality of slots located between the arms of the dipole pairs, wherein the antenna feeds protrude through the slots.

5. The antenna arrangement of claim 4, wherein each of the first and second dipole arms have a width and have arm extensions of a reduced width that extend toward the slot, wherein antenna feeds are soldered to the arm extensions.

6. The antenna arrangement of claim 5, wherein the dipole arms have a thickness that extends away from the feed board to a top of the dipole arms, wherein the antenna feeds extend beyond the thickness of the dipole arms, and wherein the antenna feeds are soldered to the tops the dipole arms.

7. The antenna arrangement of claim 2, wherein the dipoles are individual wires or plate structures.

8. The antenna arrangement of claim 1, further comprising tuning notches etched out of the ground layer and line extensions of the power network past the location of the antenna feeds, wherein the geometry of the tuning notches and the length of the line extensions optimize antenna VSWR.

9. The antenna arrangement of claim 2, further comprising tuning notches etched out of the ground layer and line extensions of the power network past the location of the antenna feeds, wherein the geometry of the tuning notches and the length of the line extensions optimize antenna VSWR.

10. An antenna arrangement, comprising:
a plurality of horizontally polarized antenna elements; and
a feed board made of an electrically insulating substrate;
wherein a power divider network and a balun section are located on a face of the feed board.

11. The antenna arrangement of claim 10, wherein the plurality of horizontally polarized antenna elements are dipoles, each with a first arm and a second arm,
wherein the first arm is connected to a first antenna feed, which provides the first arm with an RF signal of a predetermined amplitude and phase, and the second arm is connected to a second antenna feed, which provides the second arm with an RF signal of the predetermined amplitude and an opposite phase.

12. The antenna arrangement of claim 11, wherein the plurality of horizontally polarized antenna elements are located on a single dipole board.

13. The antenna arrangement of claim 12, wherein the dipole board has a plurality of slots located between the arms of the dipole pairs, wherein the antenna feeds protrude through the slots.

14. The antenna arrangement of claim 13, wherein each of the first and second dipole arms have a width and have arm extensions of a reduced width that extend toward the slot, wherein the antenna feeds are soldered to the arm extensions.

15. The antenna arrangement of claim 13, wherein the dipole arms have a thickness that extends away from the feed board to a top of the dipole arms, wherein the antenna feeds extend beyond the thickness of the dipole arms, and wherein the antenna feeds are soldered to the tops the dipole arms.

16. The antenna arrangement of claim 11, wherein the dipoles are individual wires or plate structures.

17. An antenna arrangement, comprising:
a plurality of antenna elements; and
a feed board made of an electrically insulating substrate;
wherein a power divider network and a balun section is located on a face of the feed board.

18. The antenna arrangement of claim 17, wherein the plurality of antenna elements are dipoles, each with a first arm and a second arm,
wherein the first arm is connected to a first antenna feed, which provides the first arm with an RF signal of a predetermined amplitude and phase, and the second arm is connected to a second antenna feed, which provides the second arm with an RF signal of the predetermined amplitude and an opposite phase.

19. The antenna arrangement of claim 18, wherein the antenna elements are located on a single dipole board.

20. The antenna arrangement of claim 19, wherein the dipole board has a plurality of slots located between the arms of the dipole pairs, wherein the balanced feeds protrude through the slots.

21. The antenna arrangement of claim 20, wherein each of the first and second dipole arms have a width and have arm extensions of a reduced width that extend toward the slot, wherein balanced feeds are soldered to the arm extensions.

22. The antenna arrangement of claim 21, wherein the dipole arms have a thickness that extends away from the feed board to a top of the dipole arms, wherein the balanced feeds extend beyond the thickness of the dipole arms, and wherein the balanced feeds are soldered to the tops the dipole arms.
